(19) United States
(12) Patent Application Publication
(10) Pub. No.: US 2006/0066924 A1
(43) Pub. Date: Mar. 30, 2006

(54) Device for generating a multicolor digital picture

(75) Inventor: Verner Delueg, Brixen (IT)

Correspondence Address: COLLARD & ROE, P.C., 1077 Northern Boulevard, Roslyn, NY, 11576, US

(73) Assignee: DURST PHOTOTECHNIK - A.G., Brixen (IT)

(21) Appl. No.: 11/234,894

(22) Filed: Sep. 26, 2005

(30) Foreign Application Priority Data
Sep. 27, 2004 (AT) A 1611/2004

(51) Int. Cl. H04N 1/46

(52) U.S. Cl. 358/506

(57) ABSTRACT

The invention relates to a device (1) and a method for generating on a photo-sensitive material (2) a multicolor picture composed of data of a digital image (3), with a transport system (4) for moving the material (2) in a feeding direction (5), and with an exposure head (8) adapted for reciprocating above the material (2) in a direction extending perpendicularly to the feeding direction (5). The exposure head (8) comprises a plurality of outlet ends (46) of light-conducting fibers (18) for generating pixels (62, 63) on the material (2). Coupling units (17) are formed in the device (1), by which a first light source (14), a second light source (15) and a third light source (16) each are connected to one single light-conducting fiber (18). In this connection, the color of the first light source (14), the color of the second light source (15) and the color of the third light source (16) form of triplet of complementary basic colors.

### CROSS REFERENCE TO RELATED APPLICATIONS

Applicant claims priority under 35 U.S.C. §119 of AUSTRIAN Patent Application No. A 1611/2004, filed on 27 Sep. 2004.

### BACKGROUND OF THE INVENTION

1. Field of the Invention

The invention relates to a device for generating on a photosensitive material a multicolor picture composed from data of a digital image, with a transport system for moving the material in a feeding direction, and with an exposure head that is adapted for reciprocating above the material in a direction extending perpendicular to the feeding direction, whereby the exposure head has a plurality of outlet ends of light-conducting fibers for generating pixels on the material. Furthermore, the invention relates to a device for generating on a photosensitive material a multicolor picture composed from data of a digital image, whereby the material is driven in a feeding direction by a transport system, and pixels are generated on the material by means of an exposure head, which is adapted for reciprocating above the material in a direction expending perpendicular to the feeding direction, and which has a plurality of outlet ends of light-conducting fibers.

2. Prior Art

A method and device for controlling a plurality of light sources in a digital printer are known from U.S. patent document U.S. Pat. No. 6,452,696 B1. Digital image data are employed for said purpose for exposing a photosensitive material by causing light to act on the photographic paper pixel by pixel. Each light pulse for exposing a pixel on the photographic paper is generated by a light-emitting diode (LED) in accordance with the stored digital image information, and passed through a light-conducting fiber in an exposure head, by means of which the light pulse is finally directed onto the photographic paper. The outlet ends of a plurality of light-conducting fibers are lined up in a frame of the exposure head, said outlet ends being disposed directly next to one another. The arrangement of the outlet ends of the light-conducting fibers is reproduced on the surface of the photographic paper by means of a lens system of the exposure head, so that a plurality of pixels can be exposed simultaneously. The exposure head is moved transversely across the photographic paper, so that a plurality of pixels can be generated simultaneously in the course of such a movement. The photographic paper is then advanced further by a transport system by a length corresponding with the number of lines generated first, whereupon a further sequence of lines of pixels is then transferred to the photographic paper by the exposure head moving above the paper. Furthermore, it is known from U. S. Pat. No. 6,452,696 B1 to determine correction tables by carrying out test exposures, by which any nonuniform effect of the exposure can be taken into account depending on the intensity of the exposure and the duration of the latter. In this way, it is possible to correct the effect consisting in that the exposure with a first exposure intensity, and the duration of such first exposure, are not equal to the exposure effect that is obtained, for example with half of the first exposure intensity over a time span amounting to twice the duration of the first exposure time. This effect is also referred to as the reciprocity error. It is also known already that streaks appearing along the edges between two lines of pixels disposed next to one another, such streaks being produced by the exposure head, require other corrections, as it is the case in connection with lines of pixels within the interior of a streak, in order to prevent such streaks from occurring, and thus to avoid any impairment of the quality of the picture.

### SUMMARY OF THE INVENTION

The problem of the invention is to provide a device and a method for generating on a photosensitive material a multicolor picture composed from data of a digital image. Pictures of high quality can be generated on photosensitive materials with such a device and such a method.

Said problem of the invention is resolved in that coupling units are formed, each connecting a first light source, a second light source and a third light source to one single light-conducting fiber, whereby the color of the light of the first light source, the color of the light of the second light source, and the color of the light of the third light source form a triplet of basic complementary colors. The advantage gained in this manner is that in this way, the exposure head requires only one third of the number of light-conducting fibers. The further benefit so gained is that the three colors for generating a pixel are applied in this manner simultaneously, and that a higher accuracy is achieved in this way as compared to the otherwise required successive exposures of the individual colors in a pixel.

The advantage offered by the embodiment of the device, in which the coupling unit for coupling the light sources with a fiber inlet port for admitting the light-conducting fiber comprises a first interference filter and a second interference filter, whereby the light of the first light source is reflected on the first interference filter, and the light of the second light source is reflected on the second interference filter and passes through the first interference filter, and the light of the third light source passes through both the second interference filter and the first interference filter, lies in that optimal yield of the light of the employed light sources is achieved owing to the characteristics of the curve of the degree of spectral transmission of the interference filters so employed.

The further development of the embodiment of the device, where each light source is arranged in a tube that is provided with a lens for focusing the light of the light sources on the inlet port for the light-conducting fiber, and the position of the light sources in the respective tubes is adjustable with respect to the longitudinal expanse of the respective tube, offers the advantage that a high yield of the light of the light sources can be achieved.

The embodiment of the device, where the optical axes of the lenses of the first and the second light sources, and the axis of the fiber inlet port jointly enclose an angle of 60°, and an axis of the lens is aligned parallel to the optical axis, is advantageous as well in that the light sources, the interference filters and the inlet window for the light-conducting fiber in the coupling unit can be arranged in a very compact and space-saving manner.

The embodiment of the device, where the inlet window is formed in a device for mounting the fiber, is beneficial as well in that the light-conducting fiber, which is secured in a socket, can be inserted in the mounting for holding the fiber, and fixed therein. This permits simple mounting and the light-conducting fibers can be easily connected with the coupling unit.

The further development of the embodiment of the device, where the coupling units are arranged in a stationary light source unit, offers the advantage that the weight of the exposure head can be kept as low as possible in this manner.

The embodiment of the device, in which the light sources are formed by light-emitting diodes (LED's) and/or the triplet of basic colors is formed by red, green and blue, are beneficial as well in that very precise and short light pulses can be generated with light-emitting diodes, so that the exposure head can be driven at correspondingly higher rates for moving it across the photosensitive material.

Owing to the embodiment of the device, in which each light source is connected with a control circuit, whereby the latter comprises at least one digital/analog converter and a timer, continuously variable light pulses are available for the exposure.

The embodiment of the device, in which a measuring cell is provided for measuring the light intensities of the exposure head, is advantageous in that the attainable light intensities of the exposure head can be checked in a simple manner, and in that when light-emitting diodes are employed as light sources, the nonlinear reciprocal relation between the control current and the light intensity of such light sources can be measured, and such mutual relation can be taken into account when digital pictures are exposed.

The further development of the embodiment of the device, in which a distance transmitter is provided for detecting the position of the exposure head, in advantageous in that the generation of pixels can be controlled with high precision in accordance with the lateral position of the respective pixels.

The embodiment of the device, where the exposure head comprises a lens system for reproducing on the material the outlet ends of the light-conducting fibers, offers the advantage that the outlet ends of the light-conducting fibers do not have to be moved directly above the photosensitive material. By reproducing the outlet ends of the light-conducting fibers with the lens system so provided, it is possible to avoid inaccuracies caused by divergence of the pencils of light rays exiting from the light-conducting fibers.

The benefits gained by arranging the mask with exposure apertures between the outlet ends of the light-conducting fibers and the lens system, are that both the position and the shape of the pixels can be fixed with high precision, and that mechanical inaccuracies are eliminated when the light-conducting fibers are mounted in the exposure head.

The further development of the embodiment of the device, where successively disposed exposure apertures are offset by an aperture spacing “d” with respect to a direction extending perpendicular to the directions of the movement of the exposure head, and the aperture spacing “d” has a value amounting to twice the value of a line spacing “z” of lines of the digital picture to be produced, is advantageous in that it permits application of the pixels by alternately generating lines and intermediate lines by exposing only each second line of the digital image, and subsequently exposing intermediate lines accordingly.

The embodiment of the device, in which the exposure apertures, perpendicularly to the direction of movement of the exposure head, have a height that is greater than the line spacing “z”, and such height is equal to 1.8 times the line spacing “z”, permits in an advantageous manner overlapping of lines and intermediate lines following each other successively. Picture flaws caused by inaccuracies that may become noticeable in the form of horizontal streaking, can be avoided in this manner.

The embodiment of the device, in which the exposure apertures, with respect to the direction of movement of the exposure head, have a width that is greater than the line spacing “z”, and such width is equal to 1.8 times the line spacing “z”, the advantage gained is that in this way, overlapping corresponding with the overlapping of lines and intermediate lines is obtained as well in the lateral direction between pixels neighboring on one another within a line. The formation of vertical streaks that could become noticeable as picture defects, are avoided in this way.

With the further development of the embodiment of the device, according to which lateral contours of the exposure apertures in the mask approximately correspond with a Gaussian bell curve, the benefit gained is that even if the feeding movement of the transport system is not precise, the development of the overall exposure will be as uniform as possible, and will remain preserved between two lines and intermediate lines neighboring on one another to the greatest possible extent.

The embodiment of the device, in which the exposure apertures are formed with lateral contours conforming at least approximately to a Gaussian bell curve, is advantageous in that the masks, which are formed by coated glass leaves, are available in the form of high-precision masks.

The problem of the invention is independently resolved by the method as well, in connection with which the light of a first light source, the light of a second light source, and the light of a third light source is passed through one single light-conducting fiber, whereby the color of the light of the first light source, the color of the light of the second light source, and the color of the light of the third light source form a triplet of basic colors complementing each other. The advantage gained in this manner is that it is possible to do with a third of the light-conducting fibers, and that a higher accuracy of the exposure of the individual pixels of the digital image is achievable at the same time.

Advantageous further developed implementations of the method are defined in claims 25 to 32.

An independent solution to the problem of the invention is described by the method as well, whereby at least one first line of pixels is generated in the course of a first movement of the exposure head, and at least one second line of pixels is subsequently generated during a second movement of the exposure head, whereby the first and the second lines overlap each other at least in part, and whereby prior to the generation of the second line, corrected picture data are computed for the second line by compensating for each pixel the changed exposure effect of the second exposure process following the first exposure process after a time interval, whereby such compensation is achieved by changing the intensity and/or the pulse duration by a value that is proportional to the logarithm of the ratio between the time interval and a reference time interval (value˜log(time interval)/reference time interval). The advantage gained in this connection is that a uniform effect of the overall exposure between two successive lines and intermediate lines of the digital picture can be achieved in this manner.

Advantageous implementations of the method are specified also in claims 34 to 40.

### BRIEF DESCRIPTION OF THE DRAWINGS

For the sake of better understanding, the invention is explained in greater detail in the following with the help of the following figures, which show schematically simplified representations:

FIG. 1 shows a device for exposing a photosensitive material with digital pictures.

FIG. 2 is a basic representation of a coupling unit according to FIG. 1.

FIG. 3 is a sectional representation of the exposure head (according to FIG. 1), which is arranged above the photosensitive material.

FIG. 4 shows the mask of the exposure head according to FIG. 3.

FIG. 5 shows a highly enlarged detail of the mask with two exposure apertures according to FIG. 4.

FIG. 6 is an enlarged cutout of the photosensitive material with the lines and one intermediate line exposed on said material; and

FIG. 7 is a flowchart of the method for exposing digital pictures with correction of the intermittence effect.

### DETAILED DESCRIPTION OF PREFERRED EMBODIMENTS

It is noted here by way of introduction that identical components in the different embodiments described herein are provided with identical reference numbers and identical component designations, whereby the disclosures contained throughout the specification can be applied in the same sense to identical parts with the same reference numbers or the same component designations. Furthermore, positional data selected in the specification such as, e.g. “top”, “bottom”, “lateral” etc., relate to the directly described and shown figure, and are applicable in the same sense to any new position where a position has changed. Moreover, individual features or combinations of features of the different exemplified embodiments shown and described herein may represent independent inventive solutions, or solutions as defined by the invention as well.

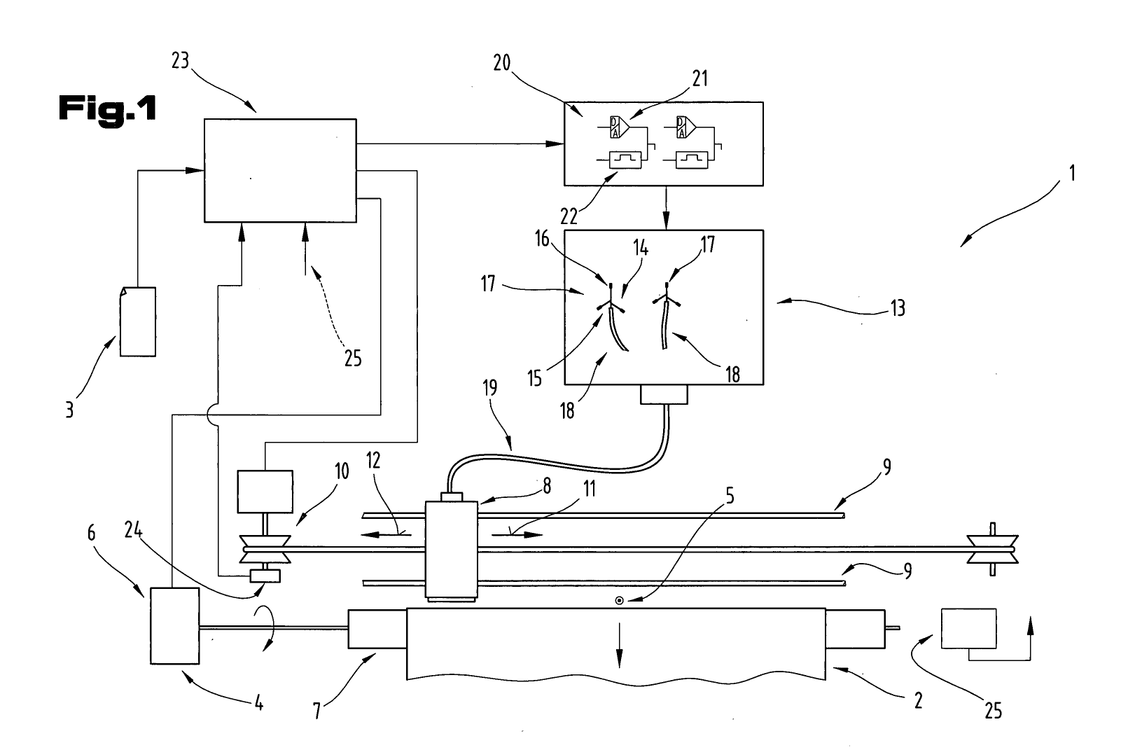

FIG. 1 shows by a schematically simplified representation a device 1 for exposing a photosensitive material 2 with the digital images 3.

For said purpose, the device 1 is provided with a transport system 4, with which the photosensitive material 2 can be moved in the feeding direction 5. The photo-sensitive material 2 is formed, for example by a photographic paper or a film. With the help of a driving roll 7 driven by a motor 6, the material 2 is moved forwards, or positioned underneath an exposure head 8. The exposure head 8 is adapted for reciprocating along the guides 9, which are aligned transversely and perpendicularly to the feeding direction 5, with the help of an exposure head drive 10. For exposing the material 2 with the exposure head 8, the latter is alternately driven in the direction 11, and driven back again in the direction 12, whereby between the transverse movements of the exposure head 8, the material 2 is advanced in the feeding direction 5 and newly positioned. The photosensitive material 2 is exposed in this manner line by line, or pixel by pixel by the exposure head 8 directing light pulses onto the material 2.

The light pulses are generated in a light source unit 13 with the light sources 14, 15 and 16, which each are preferably formed by a light-emitting diode (LED). Provision is made in this connection, for example that the light source 14 serves for generating red light, the light source 15 for generating green light, and the light source 16 for generating blue light, so that a triplet of light sources 14, 15 and 16 can generate a triplet of complementary basic colors. The light sources 14, 15 and 16 are combined in a coupling unit 17, whereby their light is combined and fed into one single light-conducting fiber 18. The light source unit 14 comprises a number of such coupling units 17, whose light is passed into the exposure head 8 by way of the light-conducting fibers 18, the latter being bundled together to form a fiber bundle 19. Corresponding with the number of the light-conducting fibers 18, it is therefore possible to simultaneously expose on the photosensitive material 2 a number of lines corresponding with the number of coupling units 17, whereby each pixel can be simultaneously exposed with the three basic colors. By correspondingly mixing the color proportions of the light sources 14, 15 and 16, their light intensity being continuously variable, it is possible to produce in a pixel any desired color.

For generating the light pulses, each of the light sources 14, 15 and 16 of each of the coupling units 17 is provided with a control circuit 20. Each of said control circuits 20 comprises at least one digital/analog converter 21 and a timer 22. The exposure process of the device 1 is carried out with the help of a central control 23, which converts the information of the digital image 3 into control signals for the transport system 4, the exposure head drive 10 and the control circuits 20 for the light sources 14, 15, 16. For the determination of the instantaneous position of the exposure head 8 or the fiber ends of the light-conducting fibers 18, the central control 23 is connected to a distance transmitter 24.

The device 1 additionally comprises a measuring cell 25 for measuring the light intensities of the exposure head 8. Particularly in the case where the light sources 14, 15 and 16 are formed by LED's, it is possible to measure any strong nonlinearity of the reciprocal relation between the control current and the light emission, by measuring the light intensities with the help of the measuring cell 25. The correction parameters derived from such measurements are taken into account in the course of the exposure. However, by periodically repeating such measurements with the measuring cell 25, it is possible also to compensate any changes caused by aging or thermal loads of the LED's. Said measuring cell 25 is preferably arranged within the area of the idle position of the exposure head 8 outside of the actual exposure range of the device 1, so that measurements with the measuring cell 25 can be carried out in an automated manner as well.

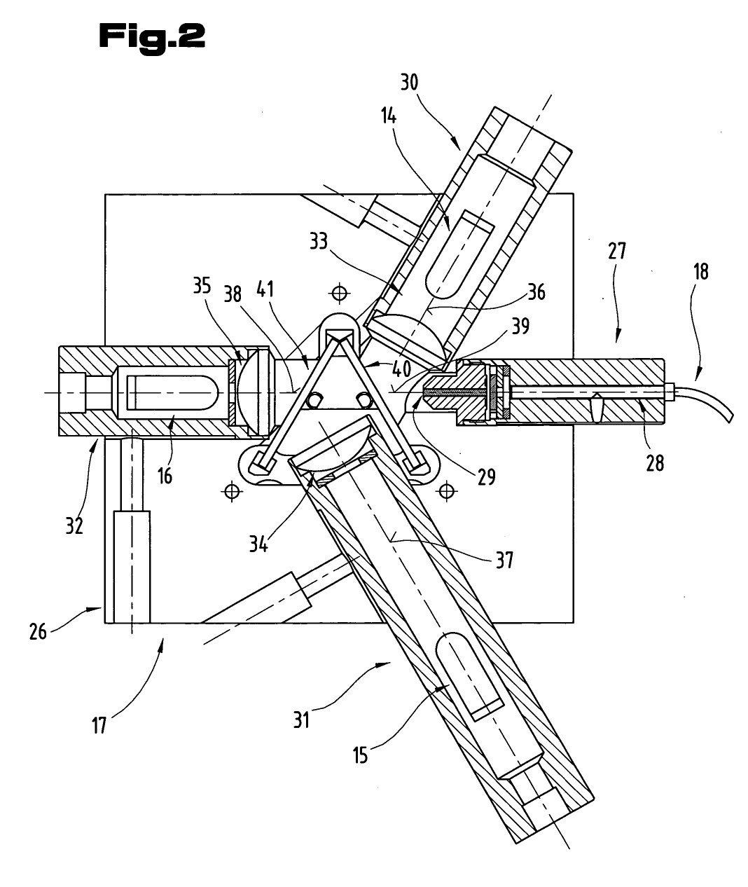

FIG. 2 shows a basic diagrammatic representation of one of the coupling units 17 according to FIG. 1.

A fiber-mounting device 27 for holding the inlet end of the light-conducting fiber 18 is arranged on a frame 26 of the coupling unit 17. For said purpose, the light-conducting fiber 18 is additionally secured in a socket 28, whereby the latter can be inserted in the fiber mounting device 27 and fixed there. At one end, the fiber mounting device 27 has a fiber inlet port 29 aligned with the longitudinal expanse of the socket 28 of the light-conducting fiber 18. The light emitted by the light sources 14, 15, 16 enters the light-conducting fiber, or is coupled into the latter by way of said inlet port. The light sources 14, 15, 16 are each supported in a holding device or tube 30, 31, 32, and the light emitted by said light sources is focused by a lens 33, 34, 35, respectively. The tubes 30, 31, 32, or the optical axes 36, 37, 38 of the lenses 33, 34, 35, respectively, are approximately aligned in a delta configuration. The optical axis 38 of the lens 35 is aligned parallel to an optical axis 39 of the inlet port 29. Contrary thereto, the optical axes 36 and 37 of the lenses 33 and 34, respectively, are aligned inclined with respect to the optical axis 39 of the inlet port 29, and the light of the light sources 14 and 15 is received in the inlet port 29 of the fiber mounting device 27 by deflection, i.e. reflection on the interference filters 40 and 41, respectively. The optical axes 36 and 37, and the optical axis 39 of the inlet port 29 preferably enclose an angle of 60°. This permits a very compact arrangement of the tubes 30, 31, 32 and interference filters 40 with respect to the fiber-mounting device 27.

The use of the interference filters 40 and 41 for deflecting the path of the beams of the light sources 14 and 15 offers the benefit that loss of light can be kept particularly low in this way. Such interference filters are formed by systems with alternating coatings, i.e. multiple coatings with an alternating high and low refractive index. Owing to the fact that the coatings are practically free of absorption, an almost loss-free division of a spectral range in reflection and transmission is possible, whereby the boundary is determined by a steep edge of the transmission curve. For deflecting the red light of the light source 14, a filter is used accordingly for the interference filter 40, of which the degree of spectral transmission for red light is almost equal zero, whereas light with a smaller wave range such as the green light of the light source 15, and the blue light of the light source 16, can pass the interference filter almost without absorption. The red light of the light source 14, on the other hand, is reflected, and enters the light-conducting fiber 18 through the inlet port 29. Analogously, the filter used as the interference filter 41 has a degree of spectral transmission for green light that is almost equal to 0, whereas the blue light of the light source 16 can pass through the interference filter 41 nearly free of loss. Accordingly, the green light of the light source 15 is reflected on the interference filter 41, and is received in the light-conducting fiber 18 by way of the inlet port 29. Thus the special feature of the light-coupling unit 17 consists in that for deflecting the course of the beam of the first light source 14 toward the inlet port 29 for admitting it to the light-conducting fiber 18, an interference filter 40 is employed whose degree of spectral transmission for the wavelength of the light of the light source 14 is almost equal to zero, whereas the degree of spectral transmission for the wavelengths of the light of the other light sources 15 and 16, which has to pass through the interference filter 40, is almost equal to 1. On the other hand, the second indifference filter 41 has a degree of spectral transmission that is almost equal to 0 for the wavelength of the light of the second light source 15, whereas the degree of spectral transmission of the light of the light source 16, which has to pass through said indifference filter 41, is almost equal to 1.

For arranging the light sources 14, 15, 16 in their tubes 30, 31, 32, respectively, provision is made that their position can be adjusted with respect to the longitudinal expanse of said tubes 30, 31, 32. In addition, provision is made for adjusting the longitudinal expanse of the tubes 30, 31, 32 with respect to the frame 26. What is achieved in this way is that the intensity of the light received in the inlet port 29 of the fiber-mounting device 27 will have the maximally attainable value.

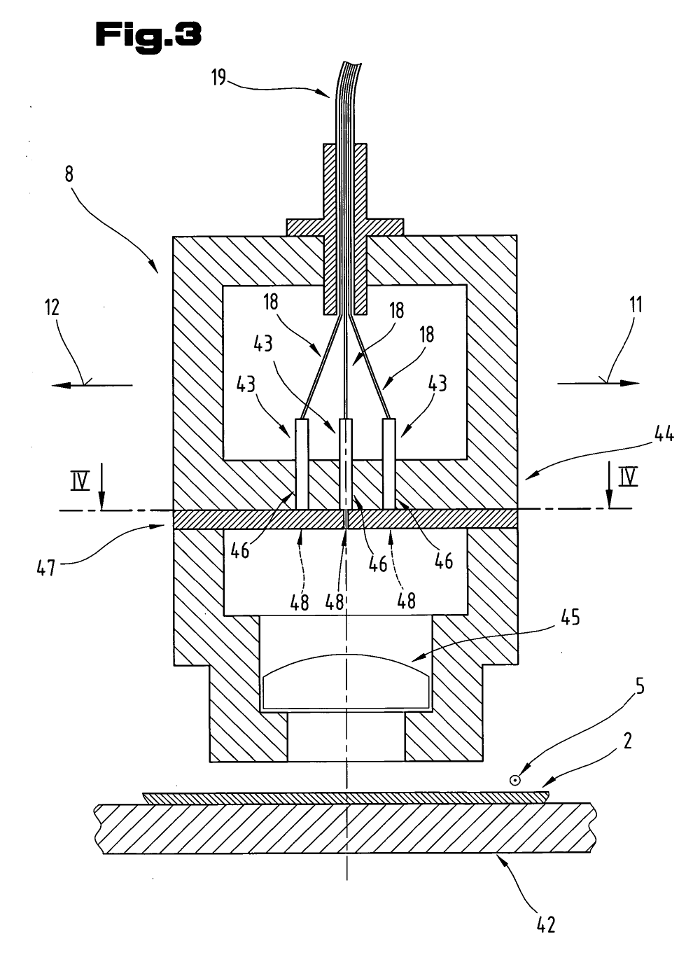

FIG. 3 is a sectional representation of the exposure head 8 (according to FIG. 1) arranged above the photosensitive material 2.

Within the area below the exposure head 8, the photosensitive material 2 is guided across a table or plate 42 with a plane top side. It is ensured in this way that the material 2 is aligned in parallel with respect to the outlet ends of the light-conducting fibers 18. The light-conducting fibers 18 conduct the light from the stationary light source unit 13 (FIG. 1) into the exposure head 8. The light-conducting fibers 18 each end in a socket 43, which is secured in a carrier 44. The light passing through the light-conducting fibers 18 is focused on the photosensitive material 2 by an interconnected lens system 45. A mask 47 with the exposure apertures 48 is arranged or interconnected between the outlet ends 46 of the light-conducting fibers 8 facing the material 2, and the lens system 45. Inaccuracies with respect to the positioning of the outlet ends 46 of the light-conducting fibers 18 are compensated by using said mask 47. Both the insertion of the light-conducting fibers 18 in the sockets 43 and the insertion of said sockets 43 in the carrier 44 are connected with mechanical inaccuracies that can be completely cancelled by the mask 47 with the exposure apertures 48, so that only inaccuracies connected with the manufacture of the mask 47 as such remain. The apertures 48 in the mask 47 each act as a shutter for the light exiting from the outlet ends 46, so that both the shape of the individual pixel dots and their relative spacing can be fixed with very high precision. By reproducing the apertures 48 of the mask 47 on the material 2 through the lens system 45 at a ratio of 1:1, it is possible to obtain on the material 2 the same accuracy of the mutual distances between the pixels and also of their form.

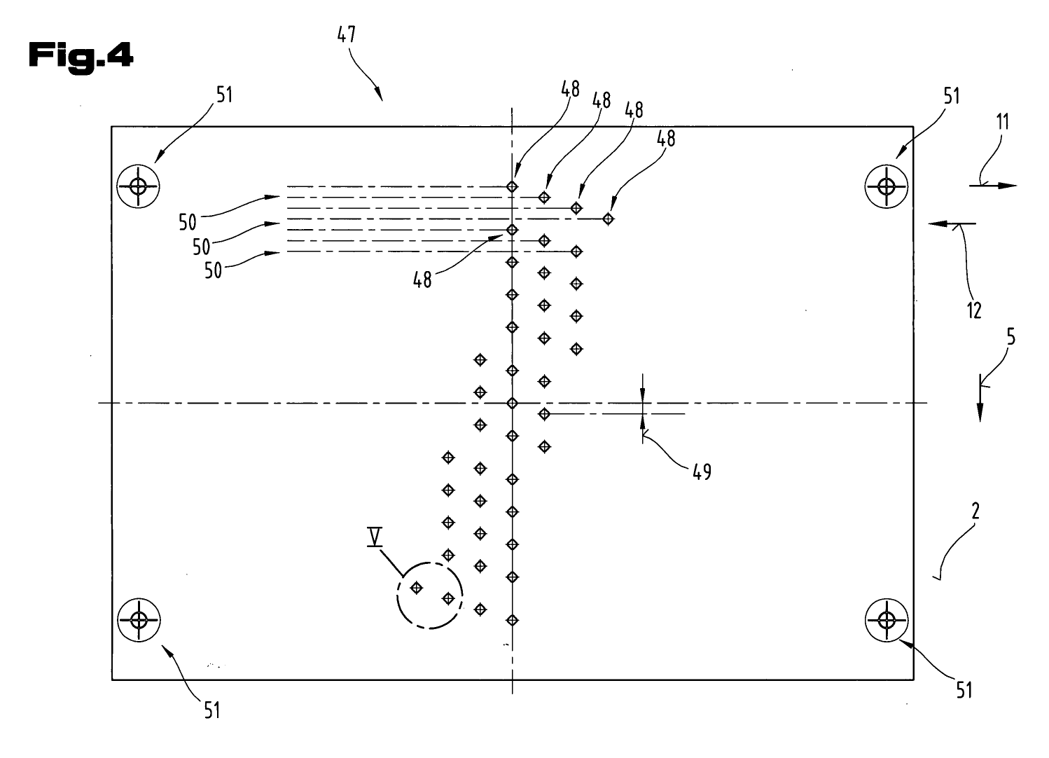

FIG. 4 shows the mask 47 of the exposure head 8 according to FIG. 3.

The apertures 48 are distributed on the mask 47 in the form of a matrix, so that perpendicularly to the directions 11 and 12 of movement of the exposure head 8, apertures 48 following one another successively are offset by an aperture spacing “d” 49. In the exemplified embodiment shown, a total of forty-one (41) of the apertures 48 is present, so that during a movement of the exposure head 8 in one of the directions 11 and 12, forty-one (41) of the lines 50 of pixels can be exposed on the material 2. This is indicated by way of example in FIG. 4 by the lines 50 shown in the upper area of the mask 47 for the direction of movement 11. For the sake of simplicity, the reversal of the picture taking place through the lens system 45 (FIG. 3) is disregarded in the further description. So that the outlet ends 46 of the light-conducting fibers 18 (FIG. 3) each can be positioned above one of the apertures 48 without mutually obstructing one another in terms of space, the apertures 48 of the lines 50 successively following one another are additionally offset against each other in the lateral direction as well, i.e. with respect to the directions 11, 12. When controlling the light sources 14, 15, 16 of different light-conducting fibers 18, such lateral offsetting of the apertures 48 needs to be taken into account by delaying the transmission of the data of the digital picture 3 to the control circuit 20 (FIG. 1) accordingly in terms of time. The mask 47 is preferably formed by a small glass leaf provided with a coating. Furthermore, the mask 47 is provided with the centering marks 51 for exactly mounting it in the exposure head 8.

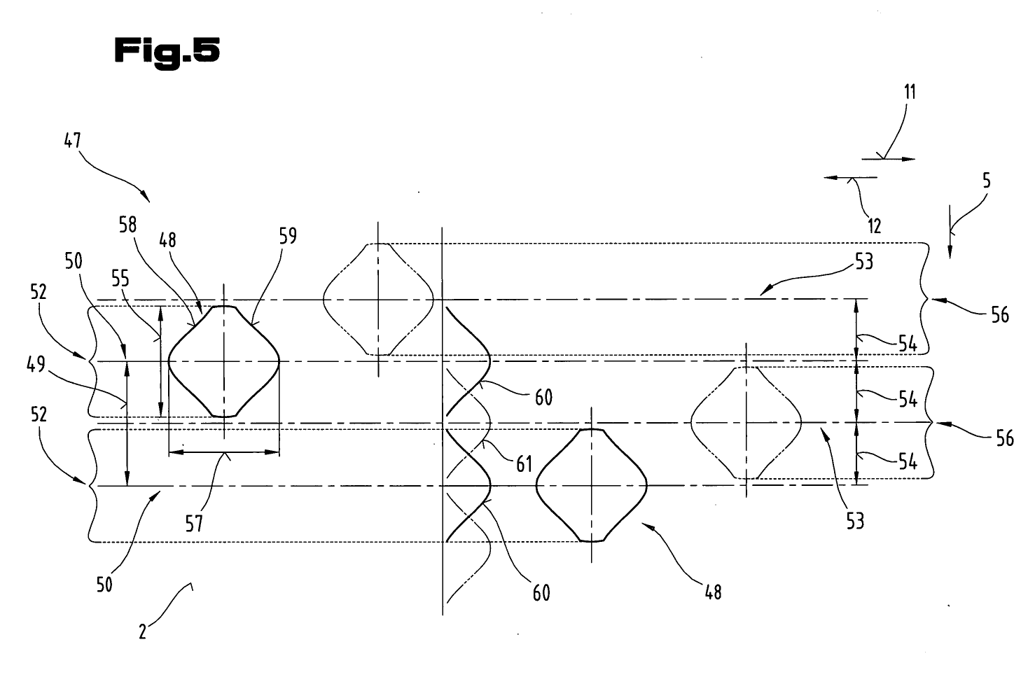

FIG. 5 shows a highly enlarged detail of the mask 47 with the two light inlet apertures 48 according to FIG. 4.

The cutout shown in FIG. 5 represents the two apertures 48 and the exposure streaks 52 indicated by dash-dotted lines, in the way such streaks are generated on the photo-sensitive material 2 as the apertures 48 are passing by, moving in the direction 11. According to the invention, provision is made that in the course of a first movement of the exposure head 8 (FIG. 1) across the material 2, only each second line 50 of the lines of the digital picture 3 to be generated is produced. After the material 2 has been advanced in the feeding direction 5 accordingly, the corresponding intermediate lines 53 are generated based on the data of the digital image in the course of a second movement of the exposure head 8. The lines 50, 53 following one another successively with respect to the feeding direction 5 thus have a line spacing “z” 54, the value of which is equal to half of the aperture spacing “d” 49. Such a method of applying lines 50 and intermediate lines 53 that are nested into one another, is also referred to by the term “interlacing”. An exposure head 8 with an uneven number of light-conducting fibers 18 or apertures 48 is preferably employed in this connection, so that the transport system 4 can be operated with a feeding length that is always the same with respect to the amount of the product of the number of light-conducting fibers 18, and comes to half of the amount of the aperture spacing “d” 49 (feeding length=number of light-conducting fibers*d/2).

According to the invention, each aperture 48 has a height 55 perpendicularly to the direction 11, 12 of the movement of the exposure head 8, with the value of said height being greater than the line spacing “z” 54. The consequence thereof is that the exposure streaks 52 of the lines 50 and the exposure streaks 56 of the intermediate lines 53 overlap each other between each two lines 50 and intermediate lines 53 following one another. Undesirable formation of streaks can be avoided in this way. With apertures 48 having a height 55 that is equal to the theoretically maximum value of the height of a pixel, i.e. equal to the line spacing “z” 54, unexposed apertures may occur as a result if the material 2 is advanced by the transport system 4 with insufficient exactitude. Such unexposed apertures are noticeable in the picture as streaks. Furthermore, provision is made that a width 57 of the aperture 48 has a value that is greater than the line spacing “z” 54. Both the height 55 and the width 57 of the aperture 48 thus extend beyond the area of the maximal theoretical expanse of a pixel. This just corresponds with a square with a side length that is equal to the line spacing “z” 54. Owing to the width 57 so selected for the aperture 48, overlapping is consequently achieved also between pixels disposed adjacent to one another within a line 50, 53. Lateral overlapping with respect to the direction 11, 12 is additionally increased by continuously moving the exposure head 8 across the photosensitive material 2 (FIG. 1). Such overlapping of the exposure areas of individual pixels in the lateral direction 11, 12 results from the distance the exposure head 8 or the aperture 48 has traveled during the duration of an exposure pulse. The maximum duration of an exposure pulse is equal to the traveling time required for covering the width of an exposure pixel corresponding with the line spacing “z” 54. A value of between 60% and 95%, particularly of 90% of the traveling time is preferably selected for the duration of the exposure pulses for the width of an exposure pixel, or of the traveling time required for covering the distance of the line spacing “z” 54.

With respect to the shape of the aperture 48, provision is made that the lateral contours 58 and 59 conform at least approximately to a Gaussian bell curve. Pixels of the material 2 disposed near the maximum width of the aperture 48, i.e. within a range close to the width 57 of the aperture 48, are thus subjected to exposure by a light pulse significantly longer than it is the case for other pixels. This is symbolically indicated by the exposure curves 60 of the exposure streaks 52, or the exposure curves 61 of the exposure streaks 56. It is easy to recognize than a superimposition of the exposure curves 60, 61 takes place in areas where the exposure streaks 52 and the exposure streaks 56 overlap one another, thus resulting in an overall exposure curve with an approximately constant development and without abrupt changes. Inaccuracies that may occur due to feeding movements by the transport system 4 not carried out with exactitude, will therefore have an only minor effect on the overall exposure curve, and are consequently practically not noticeable in the appearance of the finished, i.e. completely exposed picture. The height 55 and also the width 54 of the exposure aperture 48 are preferably equal to 1.8 times the line spacing “z” 54.

Due to the overlapping of the exposure streaks 56 of the intermediate lines 53 with the exposure streaks 52 of the lines 50, loci of the material 2 disposed within an area of overlapping are successively exposed two times, with a time interval in between. Since the effect of the exposure is different in such a case in the course of the second exposure process from the one obtained when a locus is exposed for the first time, provision is made according to the invention that a compensation is carried out by correcting the light intensities and/or the duration of the light pulses. The different exposure effect of two successively occurring exposures of a photosensitive material is known as the so-called intermittence effect of photo-physical exposure systems. The correction values for the intensity of the exposure are calculated with the help of a function having the following form:
CORR=intensity*log(t-difference/t-nominal)
Intensity: adjustable correction effect
t-difference: actual time interval
t-nominal: reference time interval.

The values for “intensity” and “t-nominal” can be determined by test exposures. “t-difference” stands for the time duration between the first exposure process and the second exposure process taking place in the same locus of the material 2.

Therefore, the method for correcting the intermittence effect consists in that at least one first line 50 of pixels 53 is generated in the course of a first movement of the exposure head 8, whereupon at least one second line 53 of pixels 62 is generated in the course of a second movement of the exposure head, whereby the first line 50 and the second line 53 overlap one another at least in part. Before the second line 53 is generated, corrected picture data are computed for the second line 53 by compensating the changed exposure effect of the second exposure process for each of the pixels 62. Such compensation takes place by changing the intensity and/or changing the pulse duration of the respective exposure pulse by a value that is proportional to the logarithm resulting from the ratio of the time interval between the exposure of the pixel 63, and the exposure of the pixel 63 and a reference time interval.

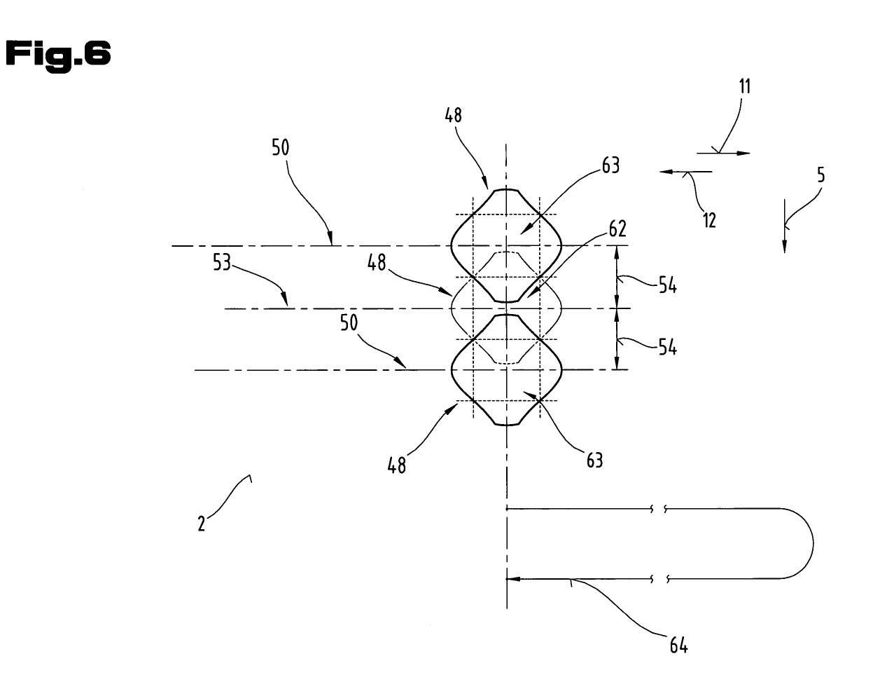

FIG. 6 shows an enlarged cutout of the photosensitive material 2 with the lines 50 and an intermediate line 53 exposed on said material.

The correction of the aforementioned intermittence effect is explained in greater detail with the help of the present representation: A pixel 62 of the intermediate line 53 and a pixel 63 of each the two neighboring lines 50 are indicated in each case by a dash-lined square with the side length corresponding with the value of the line spacing “z” 54. The contours of the exposure apertures 48 are shown as well in order to illustrate that the exposure takes place in accordance with the picture data of the digital image 3 (FIG. 1) beyond the extent of the theoretical maximum expanse of the pixels 62, 63 in terms of surface area. The consequence thereof is overlapping of the exposure streaks 52, 56 (FIG. 5), as already explained above in the description of FIG. 5.

Now, it is assumed that the exposure of the photosensitive material 2 with the lines 50 takes place in the course of a movement of the exposure head 8 (FIG. 1) in the direction 11 (according to FIG. 6 from the left to the right). In accordance with the lateral position of the pixels 63, the latter are exposed at a first point in time, whereupon the exposure head 8 is traveling up to the right-hand edge until the corresponding lines 50 have been completely exposed. The photosensitive material 2 is subsequently advanced in the feeding direction 5, so that the intermediate lines 53 can be exposed subsequently. The exposure head 8 (FIG. 1) reverses its direction of movement to the direction 12 (according to FIG. 6 from the right to the left), and the intermediate line 53 is exposed, until the pixel 62 is finally exposed at a second point in time. By measuring or calculating in advance the time difference between the first point in time of the exposure of the pixel 63, and the point in time of the exposure of the pixel 62, it is possible to compute a correction value for the light pulse required for exposing the pixel 62, and to jointly take in account said value for controlling the light sources 14, 15, 16 (FIG. 1). The time difference corresponds with a distance of travel 64 of the exposure head 8, which can be determined by detecting the position of the exposure head 8 with the help of the distance transmitter 24 (FIG. 1) and the rate of its movement. Strictly stated, for any exact determination of the corresponding time intervals, it would be necessary also to take into account the difference in travel time resulting from the lateral displacement of the exposure aperture 48. However, such difference in the travel time is negligible as compared to the total travel time. Therefore, the time sequence of the exposure curve in the course of the exposure of the photosensitive material 2 is detected, and the time interval for exposing pixels 62, 63 neighboring on one another in successive lines 50 or intermediate lines 53 is calculated, and corrected based on the time interval so determined for compensating the so-called intermittence effect. The computed correction value is added to the picture data of the digital picture 3 (FIG. 1) before the corresponding exposure cycle is carried out.

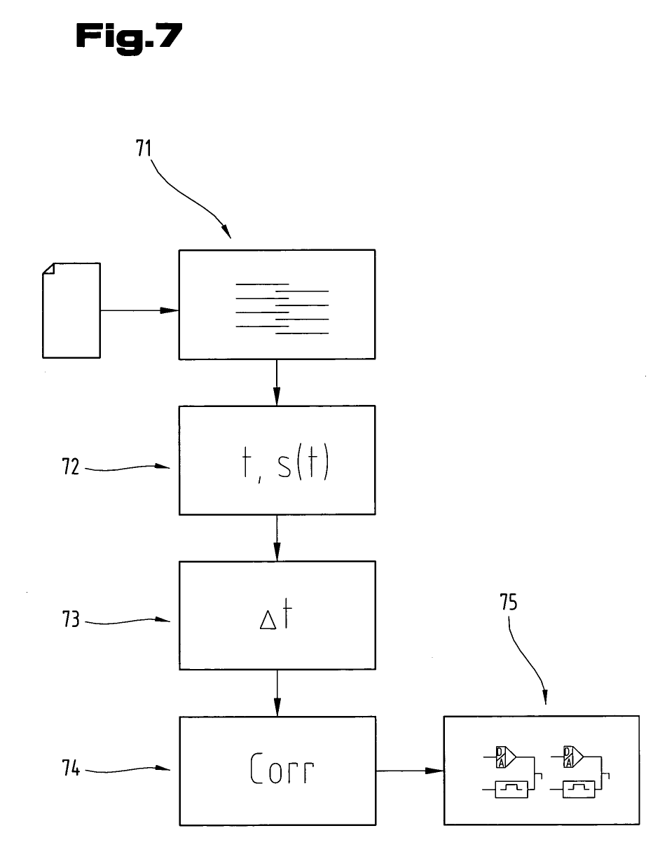

FIG. 7 shows a flowchart of the method for exposing the digital pictures 3 with correction of the intermittence effect.

Based on the picture data of a digital image 3, the picture data are divided in a first step 71 in picture data according to the line 50, and picture data according to the intermediate lines 53 (FIGS. 5 and 6), and in a further step 72, the sequence of the movement of the exposure head 8 and the feeding movement of the photosensitive material 2 (FIG. 1) are recorded. In a step 73, based on said information, time intervals or difference times are determined for the pixels 62, 63 relating to the lines 50 and intermediate lines 53. In a step 74, correction values are subsequently calculated for the exposure of the intermediate lines 53, and new corrected picture data are thereby determined for the intermediate lines 53. In a subsequent step 75, the light sources 14, 15, 16 are then controlled by alternately transmitting the picture data relating for the lines 50 and the intermediate lines 53 to the control circuit 20.

The exemplified embodiments show possible design variations of the device and the implementations of the method for generating a multicolor picture composed of data of a digital image, whereby it is noted at this point that the invention is not limited to the specifically shown design variations, but that various combinations of the individual design variations among one another are rather feasible as well, and that such variation possibility based on the instruction for technical execution falls within the skill on the expert engaged in the present technical field. Therefore, all conceivable design variations feasible by combining individual details of the design variations shown and described herein are jointly covered by the scope of protection of the present invention.

It is finally emphasized for the sake of good order that in the interest of superior understanding of the structure of the device, the latter and its components are partly shown untrue to scale and/or enlarged and/or reduced.

The problems forming the basis of the independent inventive solutions are specified in the above specification.

Above all, the embodiments shown in the individual FIGS. 1, 2; 3, 4, 5; 6, 7 form the object of independent solutions as defined by the invention. The problems and their solutions relating to such embodiments are disclosed in the detailed descriptions of said figures.

### LIST OF REFERENCE NUMBERS

1 Device
2 Material
3 Digital image
4 Transport system
5 Feeding direction
6 Motor
7 Driving roll
8 Exposure head
9 Guide
10 Exposure head drive
11 Direction
12 Direction
13 Light source unit
14 Light source
15 Light source
16 Light source
17 Light-coupling unit
18 Light-conducting fiber
19 Fiber bundle
20 Control circuit
21 D/A-converter
22 Timer
23 Central controller
24 Distance transmitter
25 Measuring cell
26 Frame
27 Fiber-mounting device
28 Socket
29 Fiber inlet port
30 Tube
31 Tube
32 Tube
33 Lens
34 Lens
35 Lens
36 Optical axis
37 Optical axis
38 Optical axis
39 Optical axis
40 Interference filter
41 Interference filter
42 Plate
43 Socket
44 Carrier
45 Lens system
46 Outlet end
47 Mask
48 Exposure aperture
49 Aperture spacing “d”
50 Line
51 Centering mark
52 Exposure streak
53 Intermediate line
54 Line spacing “z”
55 Height
56 Exposure streak
57 Width
58 Contour
59 Contour
60 Exposure curve
61 Exposure curve
62 Pixel
63 Pixel
64 Distance
70 Step
71 Step
72 Step
73 Step
74 Step

1. A device for generating on a photosensitive material a multicolor picture composed of data of a digital image, with a transport system for moving the material in a feeding direction, and with an exposure head adapted for reciprocating above the material in a direction extending perpendicularly to the feeding direction, whereby the exposure head has a plurality of outlet ends of light-conducting fibers for generating pixels on the material, wherein coupling units are formed, such units each being connected to one single light-conducting fiber by a first light source, a second light source and a third light source, whereby the color of the light of the first light source, the color of the second light source, and the color of the third light source form a triplet of complementary basic colors.

2. The device according to claim 1, wherein the coupling unit for connecting the light sources to a fiber inlet port for the light-conducting fiber comprises a first interference filter and a second interference filter, whereby the light of the first light source is reflected on the first interference filter, and the light of the second light source is reflected on the second interference filter, and passes through the first interference filter, and the light of the third light source passes through both the second interference filter and the first interference filter.

3. The device according to claim 1, wherein the light sources each are arranged in a tube each equipped with a lens for focusing the light of the light sources on the fiber inlet port for the light-conducting fiber.

4. The device according to claim 3, wherein the position of the light sources in the individual tubes is adjustable with respect to the longitudinal expanse of the tubes.

5. The device according to claim 3, wherein the optical axes of the lenses of the first and the second light sources, and the axis of the fiber inlet port jointly enclose an angle of 60°, and an axis of the lens is aligned parallel to the optical axis.

6. The device according to claim 2, wherein the fiber inlet port is formed in a fiber-mounting device, whereby the light-conducting fiber is secured in a socket and insertable in the fiber-mounting device and fixable in the latter.

7. The device according to claim 2, wherein the coupling units are arranged in a stationary light source unit.

8. The device according to claim 1, wherein the light sources are formed by light-emitting diodes (LED's).

9. The device according to claim 1, wherein the triplet of basic colors is formed by red, green and blue.

10. The device according to claim 1, wherein each of the light sources is connected to a control circuit, whereby the control circuit comprises at least one digital-analog converter and a timer.

11. The device according to claim 1, wherein it comprises a measuring cell for measuring the light intensities of the exposure head.

12. The device according to claim 11, wherein the measuring cell is arranged is an idle position of the exposure head, said position located outside of the area of exposure.

13. The device according to claim 1, wherein it comprises a distance transmitter for detecting the position of the exposure head.

14. The device according to claim 1, wherein the exposure head comprises a lens system for reproducing on the material the outlet ends of the light-conducting fibers.

15. The device according to claim 14, wherein a mask with exposure apertures is arranged between the light-conducting fibers and the lens system.

16. The device according to claim 15, wherein exposure apertures following one another are offset by an aperture spacing “d” with respect to a direction extending perpendicularly to the directions the movement of the exposure head.

17. The device according to claim 15, wherein the aperture spacing “d” has a value equal to the double of a line spacing “z” of lines of the digital picture to be generated.

18. The device according to claim 15, wherein perpendicularly to the direction of movement of the exposure head, the exposure apertures have a height having a value greater than the line spacing “z”.

19. The device according to claim 18, wherein the height is equal to 1.8 times the amount of the line spacing “z”.

20. The device according to claim 15, wherein with respect to the direction of movement of the exposure head, the exposure apertures have a width having a value greater than the line spacing “z”.

21. The device according to claim 20, wherein the width is equal to 1.8 times the amount of the line spacing “z”.

22. The device according to claim 15, wherein the exposure apertures are formed with lateral contours at least approximately conforming to a Gaussian bell curve.

23. The device according to claim 15, wherein the mask is formed by a glass leaf provided with a coating.

24. A method for generating on a photosensitive material a multicolor picture composed of data of a digital image, whereby the material is driven by a transport system in a feeding direction, and pixels are generated on the material by an exposure head adapted for reciprocating above the material in a direction extending perpendicularly to the feeding direction, and having a plurality of outlet ends of light-conducting fibers, wherein the light of a first light source, the light of a second light source, and the light of a third light source is passed through one single light-conducting fiber, whereby the color of the light of the first light source, the color of the light of the second light source, and the color of the light of the third light source form a triplet of complementary basic colors.

25. The method according to claim 24, wherein for introducing the light in the light-conducting fibers, use is made of a first interference filter and a second interference filter, whereby the light of the first light source is reflected on the first interference filter, and the light of the second light source is reflected on the second interference filter and passes through the first interference filter, and the light of the third light source passes through the second interference filter and through the first interference filter.

26. The method according to claim 24, wherein for reproducing the outlet ends of the light-conducting fibers on the material, a mask with exposure apertures in arranged in the exposure head between the outlet ends of the light-conducting fibers and a lens system.

27. The method according to claim 24, wherein in the course of a first movement of the exposure head, only each second line of the lines of the digital picture to be produced is generated; the material is subsequently advanced further in the feeding direction; and intermediate lines are then generated in the course of a second movement of the exposure head.

28. The method according to claim 26, wherein with respect to the direction of movement of the exposure head, the apertures are formed with a height having a value greater than the line spacing “z”, and exposure streaks of lines and exposure streaks of intermediate lines are generated, whereby exposure streaks of lines and intermediate lines successively following one another partly overlap each other.

29. The method according to claim 28, wherein prior to generating intermediate lines, corrected picture data are computed for each pixel of the intermediate lines by compensating the changed exposure effect of the second exposure process following the first exposure process after a time interval, whereby such compensation takes place by changing the intensity and/or changing the pulse duration by a value proportional to the logarithm of the ratio between the time interval and a reference time interval (value˜log(time interval/reference time interval)).

30. The method according to claim 29, wherein test exposures are carried out, and that based on such test exposures, the reference time interval and a proportionality factor are determined for the specific photosensitive material for the value of the change in the pulse duration, and/or a proportionality factor for the value of the change in pulse duration.

31. The method according to claim 24, wherein the light sources are formed by light-emitting diodes (LED's).

32. The method according to claim 31, wherein the light intensities of the exposure head for different control currents of the LED's are measured with a measuring cell, and that correction parameters for compensating nonlinearities of the LED's are determined.

33. A method for generating on a photosensitive material a multicolor picture composed of data of a digital image, whereby the material is driven in a feeding direction by a transport system, and pixels are generated on the material by an exposure head adapted for reciprocating above the material in a direction extending perpendicularly to the feeding direction, and having a plurality of outlet ends of light-conducting fibers, wherein in the course of a first movement of the exposure head, at least one first line of pixels is generated, and at least one second line of pixels is subsequently generated in the course of a second movement of the exposure head, whereby the first line and the second line overlap one another at least in part, and whereby prior to the generation of the second line, corrected picture data are computed for the second line by compensating for each pixel a changed exposure effect of the second exposure process following the first exposure process after a time interval, whereby such compensation takes place by changing the intensity and/or changing the pulse duration by a value proportional to the logarithm of the ratio between the time interval and a reference time interval (value˜log(time interval/reference time interval)).

34. The method according to claim 33, wherein test exposures are carried out, and that based on such test exposures, a reference time interval and a proportionality factor are determined for the specific photosensitive material for the value of the change in the intensity, and/or a proportionality factor for the value of the change in pulse duration.

35. The method according to claim 33, wherein in the course of a first movement of the exposure head, only each second line of the lines of the digital picture to be produced is generated, and the material is subsequently advanced further in the feeding direction, and intermediate lines are then generated in the course of a second movement of the exposure head.

36. The method according to claim 33, wherein the light of a first light source, the light of a second light source, and the light of a third light source is passed through one single light-conducting fiber, whereby the color of the light of the first light source, the color of the light of the second light source, and the color of the light of the third light source form a triplet of complementary basic colors.

37. The method according to claim 36, wherein a first interference filter and a second interference filter are employed for introducing the light into the light-conducting fiber, whereby the light of the first light source is reflected on the first interference filter, and the light of the second light source passes through the first interference filter, and the light of the third light source passes through the second interference filter and through the first interference filter.

38. The method according to claim 33, wherein a mask with exposure apertures is arranged in the exposure head between the outlet ends of the light-conducting fibers and a lens system for reproducing the light-conducting fibers on the material.

39. The method according to claim 33, wherein the light sources are formed by light-emitting diodes (LED).

40. The method according to claim 39, wherein the light intensities of the exposure head are measured for different control currents of the LED's with a measuring cell, and that correction parameters are determined for compensating nonlinearities of the LED's.
